(19) United States
(12) Patent Application Publication
(10) Pub. No.: US 2024/0149875 A1
(43) Pub. Date: May 9, 2024

(54) VEHICLE CONTROL METHOD, VEHICLE CONTROL SYSTEM, AND VEHICLE SPEED MANAGEMENT METHOD

(71) Applicant: TOYOTA JIDOSHA KABUSHIKI KAISHA, Toyota-shi Aichi-ken (JP)

(72) Inventor: Yoshihide NAKANE, Okazaki-shi Aichi-ken (JP)

(73) Assignee: TOYOTA JIDOSHA KABUSHIKI KAISHA, Toyota-shi Aichi-ken (JP)

(21) Appl. No.: 18/371,494

(22) Filed: Sep. 22, 2023

(30) Foreign Application Priority Data
Nov. 7, 2022 (JP) 2022-178167

(51) Int. Cl. B60W 30/14; B60W 40/105; B60W 50/14

(52) U.S. Cl. CPC B60W 30/146; B60W 40/105; B60W 50/14; B60W 2050/146; B60W 2555/60

(57) ABSTRACT

A vehicle control system controls a vehicle. A meter vehicle speed presented to a user of the vehicle is higher than an actual vehicle speed of the vehicle. The vehicle control system acquires, as a first vehicle speed, a vehicle speed designated by the user or a speed limit of a road on which the vehicle travels. The vehicle control system sets a set vehicle speed to be higher than the first vehicle speed, controls a speed of the vehicle such that the meter vehicle speed does not exceed the set vehicle speed. A difference between the set vehicle speed and the first vehicle speed is equal to or less than a difference between the meter vehicle speed and the actual vehicle speed.

### CROSS-REFERENCES TO RELATED APPLICATION

The present disclosure claims priority to Japanese Patent Application No. 2022-178167, filed on Nov. 7, 2022, the contents of which application are incorporated herein by reference in their entirety.

### TECHNICAL FIELD

The present disclosure relates to a technique for controlling a vehicle. The present disclosure also relates to a technique for managing a speed of a vehicle.

### BACKGROUND ART

Patent Literature 1 discloses a driving support device for a vehicle. The driving support device sets a speed limit designated by a road sign as an upper limit speed of the vehicle.

### LIST OF RELATED ART

Patent Literature 1: Japanese Patent No. 6575560

### SUMMARY

A general vehicle is designed such that a meter vehicle speed displayed on a speedometer is higher than an actual vehicle speed. In such the vehicle, when vehicle speed control is performed such that the meter vehicle speed does not exceed a desired vehicle speed, a difference between the actual vehicle speed and the desired vehicle speed occurs. This causes a user of the vehicle to feel a sense of strangeness.

An object of the present disclosure is to provide a technique capable of suppressing a user's sense of strangeness when a meter vehicle speed presented to a user of a vehicle is higher than an actual vehicle speed of the vehicle.

A first aspect is directed to a vehicle control method for controlling a vehicle.

A meter vehicle speed presented to a user of the vehicle is higher than an actual vehicle speed of the vehicle.

The vehicle control method includes:
acquiring, as a first vehicle speed, a vehicle speed designated by the user or a speed limit of a road on which the vehicle travels;
setting a set vehicle speed to be higher than the first vehicle speed; and
controlling a speed of the vehicle such that the meter vehicle speed does not exceed the set vehicle speed.

A difference between the set vehicle speed and the first vehicle speed is equal to or less than a difference between the meter vehicle speed and the actual vehicle speed.

A second aspect is directed to a vehicle control system for controlling a vehicle.

A meter vehicle speed presented to a user of the vehicle is higher than an actual vehicle speed of the vehicle.

The vehicle control system includes one or more processors.

The one or more processors are configured to:
acquire, as a first vehicle speed, a vehicle speed designated by the user or a speed limit of a road on which the vehicle travels;
set a set vehicle speed to be higher than the first vehicle speed; and
control a speed of the vehicle such that the meter vehicle speed does not exceed the set vehicle speed.

A difference between the set vehicle speed and the first vehicle speed is equal to or less than a difference between the meter vehicle speed and the actual vehicle speed.

A third aspect is directed to a vehicle speed management method for managing a speed of a vehicle.

A meter vehicle speed presented to a user of the vehicle is higher than an actual vehicle speed of the vehicle.

The speed of the vehicle is controlled such that the meter vehicle speed does not exceed a set vehicle speed.

The vehicle speed management method includes:
acquiring, as a first vehicle speed, a vehicle speed designated by the user or a speed limit of a road on which the vehicle travels; and
setting the set vehicle speed to be higher than the first vehicle speed.

A difference between the set vehicle speed and the first vehicle speed is equal to or less than a difference between the meter vehicle speed and the actual vehicle speed.

According to the present disclosure, the meter vehicle speed is higher than the actual vehicle speed, and the vehicle speed control is performed such that the meter vehicle speed does not exceed the set vehicle speed. The set vehicle speed is set to be higher than the first vehicle speed. Further, the difference between the set vehicle speed and the first vehicle speed is equal to or less than the difference between the meter vehicle speed and the actual vehicle speed. Thus, a difference between the actual vehicle speed and the first vehicle speed is suppressed. As a result, the user's sense of strangeness is suppressed. Further, it is not necessary for the user to correct the first vehicle speed or the set vehicle speed in advance in consideration of the difference between the meter vehicle speed and the actual vehicle speed. Therefore, a load imposed on the user is reduced.

### BRIEF DESCRIPTION OF DRAWINGS

FIG. 1 is a conceptual diagram for explaining an overview of a vehicle and a vehicle control system according to an embodiment;

FIG. 2 is a conceptual diagram for explaining a method of setting a set vehicle speed according to an embodiment;

FIG. 3 is a block diagram showing a configuration example of a vehicle control system according to an embodiment;

FIG. 4 is a flowchart showing an example of processing performed by a vehicle control system according to an embodiment;

FIG. 5 is a flowchart showing a modification example of processing by a vehicle control system according to an embodiment; and

FIG. 6 is a conceptual diagram showing an example of displaying on a speedometer according to an embodiment.

### DETAILED DESCRIPTION

Embodiments of the present disclosure will be described with reference to the accompanying drawings.

### 1. OVERVIEW

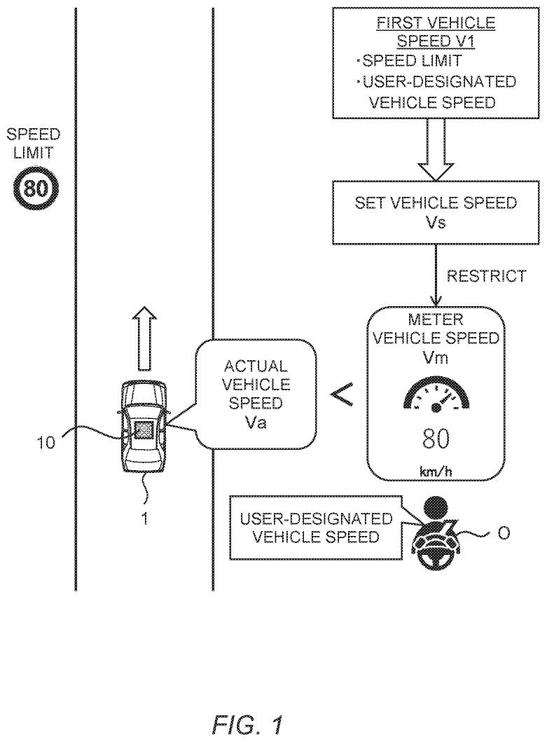

FIG. 1 is a conceptual diagram for explaining an overview of a vehicle 1 and a vehicle control system 10 according to the present embodiment. A user O of the vehicle 1 is an operator of the vehicle 1. The operator of the vehicle 1 may be a driver in the vehicle 1 or may be a remote operator who remotely operates (remotely drives or remotely supports) the vehicle 1. The vehicle 1 may be an autonomous driving vehicle.

A speed of the vehicle 1 is presented to the user O of the vehicle 1. For example, the vehicle 1 is provided with a speedometer that displays the speed of the vehicle 1. As another example, a remote operator terminal operated by a remote operator may be provided with a speedometer that displays the speed of the vehicle 1. The vehicle speed presented to the user O is hereinafter referred to as a “meter vehicle speed Vm.” On the other hand, an actual speed (ground speed) of the vehicle 1 is hereinafter referred to as an “actual vehicle speed Va.” In general, the meter vehicle speed Vm is designed to be higher than the actual vehicle speed Va (i.e., Vm>Va). Setting the meter vehicle speed Vm to be higher than the actual vehicle speed Va may be required by regulations. A relationship between the meter vehicle speed Vm and the actual vehicle speed Va may be determined in advance (e.g., Vm=1.05×Va).

The vehicle control system 10 controls the vehicle 1. The vehicle control system 10 may be mounted on the vehicle 1 or may be included in a remote operator terminal operated by a remote operator. Alternatively, the vehicle control system 10 may be distributed to the vehicle 1 and the remote operator terminal.

For example, the vehicle control system 10 executes “vehicle speed control” that controls the speed of the vehicle 1. In particular, the vehicle control system 10 sets a “set vehicle speed Vs” and executes the vehicle speed control such that the meter vehicle speed Vm does not exceed the set vehicle speed Vs.

For example, the vehicle control system 10 executes overspeed prevention control for preventing the speed of the vehicle 1 from exceeding a speed limit. In this case, the vehicle control system 10 acquires information on the speed limit of a road on which the vehicle 1 travels, and sets the set vehicle speed Vs based on the speed limit. As another example, the vehicle control system 10 may acquire a user-designated vehicle speed designated by the user O of the vehicle 1, and set the set vehicle speed Vs based on the user-designated vehicle speed. Hereinafter, the speed limit of the road on which the vehicle 1 travels or the user-designated vehicle speed designated by the user O of the vehicle 1 is referred to as a “first vehicle speed V1.” The first vehicle speed V1 can also be referred to as a “desired vehicle speed.” The vehicle control system 10 sets the set vehicle speed Vs based on the first vehicle speed V1, and executes the vehicle speed control such that the meter vehicle speed Vm does not exceed the set vehicle speed Vs.

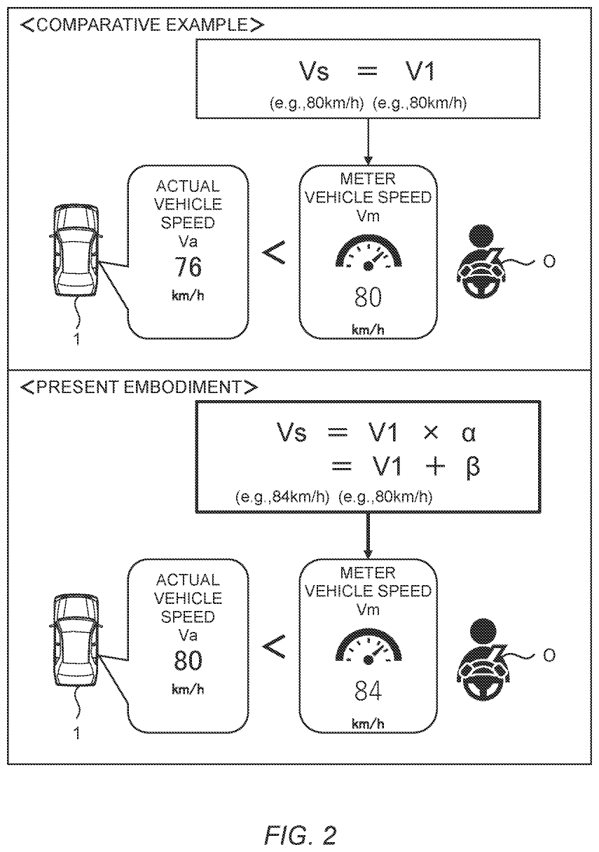

FIG. 2 is a conceptual diagram for explaining a method of setting the set vehicle speed Vs in more detail.

First, a comparative example shown in an upper part of FIG. 2 will be described. In the comparative example, the first vehicle speed V1 is set as the set vehicle speed Vs as it is (i.e., Vs=V1). In this case, the vehicle speed control is executed such that the meter vehicle speed Vm does not exceed the first vehicle speed V1. However, as described above, the meter vehicle speed Vm becomes higher than the actual vehicle speed Va. Therefore, even if the meter vehicle speed Vm is equal to the desired first vehicle speed V1, the actual vehicle speed Va is lower than the desired first vehicle speed V1. That is, a difference between the actual vehicle speed Va and the desired first vehicle speed V1 occurs. This causes the user O of the vehicle 1 to feel a sense of strangeness. It may be conceivable that the user O corrects the first vehicle speed V1 in advance in consideration of the difference between the meter vehicle speed Vm and the actual vehicle speed Va, but in that case an extra work is created for the user O.

In view of the above, according to the present embodiment, the vehicle control system 10 sets the set vehicle speed Vs such that the difference between the actual vehicle speed Va and the first vehicle speed V1 is smaller than that in the case of the above-described comparative example. More specifically, the vehicle control system 10 sets the set vehicle speed Vs to be higher than the first vehicle speed V1. The set vehicle speed Vs is expressed by the following Equation (1).

Vs=V1×α=V1+β [Equation (1)]

A correction coefficient α in the Equation (1) is larger than 1 (i.e., α>1). In addition, the correction coefficient α is equal to or less than a ratio Vm/Va between the meter vehicle speed Vm and the actual vehicle speed Va (i.e., α≤Vm/Va). For example, the correction coefficient α is set to be equal to the ratio Vm/Va (i.e., α=Vm/Va). In this case, Vs=V1×Vm/Va. Therefore, when the meter vehicle speed Vm is equal to the set vehicle speed Vs, the actual vehicle speed Va is equal to the first vehicle speed V1. Since there is no difference between the actual vehicle speed Va and the first vehicle speed V1, the user O's sense of strangeness is suppressed. It should be noted that even when the correction coefficient α is larger than 1 and smaller than the ratio Vm/Va, the difference between the actual vehicle speed Va and the first vehicle speed V1 is smaller than that in the case of the above-described comparative example. That is, when the correction coefficient α is greater than 1 and equal to or less than the ratio Vm/Va, at least the effect can be obtained.

A correction amount β in the Equation (1) is larger than 0 (i.e., (β>0). In addition, the correction amount β is equal to or less than a difference “Vm−Va” between the meter vehicle speed Vm and the actual vehicle speed Va (i.e., (β≤Vm−Va). For example, the correction amount β is set to be equal to the difference Vm−Va (i.e., (β=Vm−Va). In this case, Vs=V1+Vm−Va. Therefore, when the meter vehicle speed Vm is equal to the set vehicle speed Vs, the actual vehicle speed Va is equal to the first vehicle speed V1. Since there is no difference between the actual vehicle speed Va and the first vehicle speed V1, the user O's sense of strangeness is suppressed. It should be noted that even when the correction amount β is larger than 0 and smaller than the difference Vm−Va, the difference between the actual vehicle speed Va and the first vehicle speed V1 is smaller than that in the case of the above-described comparative example. That is, when the correction amount β is greater than 0 and equal to or less than the difference Vm−Va, at least the effect can be obtained.

As described above, according to the present embodiment, the meter vehicle speed Vm is higher than the actual vehicle speed Va, and the vehicle speed control is performed such that the meter vehicle speed Vm does not exceed the set vehicle speed Vs. The set vehicle speed Vs is set to be higher than the first vehicle speed V1. Further, the difference between the set vehicle speed Vs and the first vehicle speed V1 is equal to or less than the difference between the meter vehicle speed Vm and the actual vehicle speed Va. Thus, the difference between the actual vehicle speed Va and the first vehicle speed V1 is suppressed. As a result, the user O's sense of strangeness is suppressed. In addition, it is not necessary for the user O to correct the first vehicle speed V1 or the set vehicle speed Vs in advance in consideration of the difference between the meter vehicle speed Vm and the actual vehicle speed Va. Therefore, a load imposed on the user O is reduced.

Hereinafter, an example of the vehicle control system 10 according to the present embodiment will be described in more detail.

### 2. EXAMPLE OF VEHICLE CONTROL SYSTEM

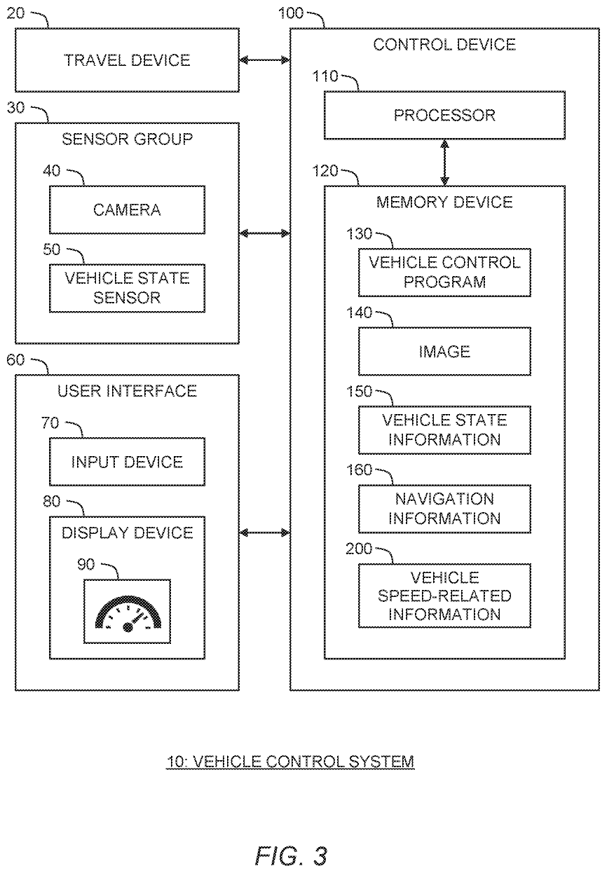

FIG. 3 is a block diagram showing a configuration example of the vehicle control system 10 according to the present embodiment. The vehicle control system 10 includes a travel device 20, a sensor group 30, a user interface 60, and a control device (controller) 100.

The travel device 20 is mounted on the vehicle 1. The traveling device 20 includes a steering device, a driving device, and a braking device. The steering device steers wheels. The driving device is a power source that generates a driving force. Examples of the driving device include an engine, an electric motor, an in-wheel motor, and the like. The braking device generates a braking force.

The sensor group 30 is mounted on the vehicle 1. The sensor group 30 includes a camera 40, a vehicle state sensor 50, and the like. The camera 40 takes a picture of a situation around the vehicle 1 and captures an image 140 indicating the situation around the vehicle 1. The vehicle state sensor 50 detects a state of the vehicle 1. For example, the vehicle state sensor 50 includes a vehicle speed sensor that detects the speed (i.e., the actual vehicle speed Va) of the vehicle 1. The sensor group 30 may include a global navigation satellite system (GNSS) that detects a position and an orientation of vehicle 1. The sensor group 30 may include a recognition sensor such as a LIDAR and the like.

The user interface 60 receives an input of information from the user O of the vehicle 1 and presents information to the user O of the vehicle 1. When the user O is a driver or an occupant on board the vehicle 1, the user interface 60 is mounted on the vehicle 1. When the user O is a remote operator who remotely operates the vehicle 1, the user interface 60 is included in the remote operator terminal.

The user interface 60 includes an input device 70 and a display device 80. Examples of the input device 70 include a touch panel, a switch, and the like. Examples of the display device 80 include a meter panel, a display, a head-up display (HUD), and the like. In addition, the display device 80 includes a speedometer 90 that displays the meter vehicle speed Vm.

The control device 100 is a computer that controls the vehicle 1. The control device 100 includes one or more processors 110 (hereinafter, simply referred to as a processor 110) and one or more memory devices 120 (hereinafter, simply referred to as a memory device 120). The processor 110 executes a variety of processing. For example, the processor 110 includes a central processing unit (CPU). The memory device 120 stores a variety of information. Examples of the memory device 120 include a volatile memory, a nonvolatile memory, a hard disk drive (HDD), a solid state drive (SSD), and the like. It should be noted that the one or more processors 110 may be installed on the vehicle 1, may be included in the remote operator terminal, or may be distributed to the vehicle 1 and the remote operator terminal. Similarly, the one or more memory devices 120 may be installed on the vehicle 1, may be included in the remote operator terminal, or may be distributed to the vehicle 1 and the remote operator terminal.

A vehicle control program 130 is a computer program for controlling the vehicle 1. A variety of processing by the processor 110 (the vehicle control system 10) may be implemented by the processor 110 executing the vehicle control program 130. The vehicle control program 130 is stored in the memory device 120. Alternatively, the vehicle control program 130 may be recorded on a non-transitory computer-readable recording medium.

The memory device 120 further stores an image 140, vehicle state information 150, navigation information 160, vehicle speed-related information 200, and the like.

The image 140 is captured by the camera 40 mounted on the vehicle 1. When the processor 110 is included in the remote operator terminal, the processor 110 communicates with the vehicle 1 to acquire the image 140.

The vehicle state information 150 is acquired by the vehicle state sensor 50 mounted on the vehicle 1. For example, the vehicle state information 150 includes the speed (i.e., the actual vehicle speed Va) of the vehicle 1. When the processor 110 is included in the remote operator terminal, the processor 110 communicates with the vehicle 1 to acquire the vehicle state information 150.

The navigation information 160 includes map information and position information of the vehicle 1. The position information of the vehicle 1 is acquired from the GNSS. The map information is stored in advance in the memory device 120. Alternatively, the map information may be high-definition three-dimensional map information provided from a map management server. The processor 110 is able to acquire the high-definition three-dimensional map information by communicating with the map management server.

The vehicle speed-related information 200 includes information of the first vehicle speed V1, the set vehicle speed Vs, the meter vehicle speed Vm, and the actual vehicle speed Va. The actual vehicle speed Va is obtained from the vehicle state information 150. A tire diameter and a vehicle dimension may be taken into account. Alternatively, the actual vehicle speed Va may be calculated based on the position information acquired from the GNSS. The vehicle speed-related information 200 may further include information indicating the relationship between the meter vehicle speed Vm and the actual vehicle speed Va.

The processor 110 controls travel of the vehicle 1 by controlling the travel device 20 (i.e., the steering device, the driving device, and the braking device). For example, the processor 110 executes the vehicle speed control by controlling the driving device and the braking device. In addition, the processor 110 determines the meter vehicle speed Vm based on the actual vehicle speed Va, and displays the meter vehicle speed Vm on the speedometer 90. Furthermore, the processor 110 sets the set vehicle speed Vs.

Hereinafter, processing related to the set vehicle speed Vs will be described in detail.

### 3. PROCESSING RELATED TO SET VEHICLE SPEED VS

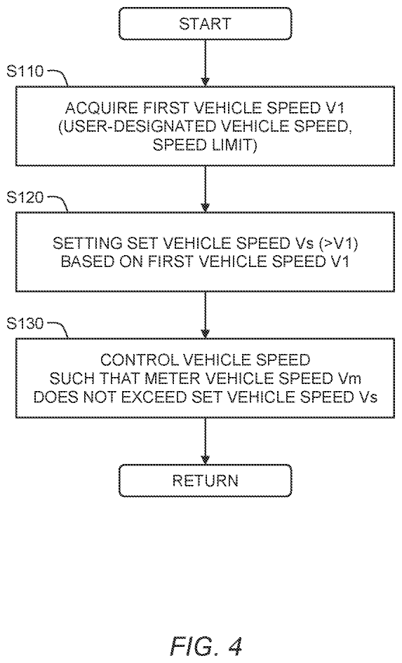

FIG. 4 is a flowchart showing an example of the processing related to the set vehicle speed Vs.

### 3-1. Step S110

In Step S110, the processor 110 acquires the first vehicle speed V1.

For example, the first vehicle speed V1 is a user-designated vehicle speed designated by the user O of the vehicle 1. The user O uses the input device 70 to input the user-designated vehicle speed. The processor 110 receives information on the user-designated vehicle speed through the input device 70.

As another example, the first vehicle speed V1 is a speed limit of a road on which the vehicle 1 travels. For example, a speed limit sign designating the speed limit is installed on the road. The processor 110 recognizes the speed limit sign by analyzing the image 140 captured by the camera 40. Typically, the processor 110 recognizes the speed limit sign from the image 140 by using image recognition AI (Artificial Intelligence). The image recognition AI is generated in advance through a learning method such as deep learning. On the basis of the image of the recognized speed limit sign, the processor 110 reads numbers (the speed limit) shown on the speed limit sign. In other words, the processor 110 recognizes the speed limit designated by the speed limit sign on the basis of the image of the recognized speed limit sign.

As another example, a speed limit for each road may be registered in the map information (high-definition three-dimensional map information). In this case, the processor 110 can acquire the information on the speed limit from the navigation information 160.

As still another example, the processor 110 may identify a road type (for example, an expressway) of the road on which the vehicle 1 is traveling based on the navigation information 160. Then, the processor 110 may acquire a legal speed limit set for the road type.

### 3-2. Step S120

In Step S120, the processor 110 sets the set vehicle speed Vs based on the first vehicle speed V1. The set vehicle speed Vs is expressed by the above Equation (1). The correction coefficient α and the correction amount β are as described above. The relationship between the meter vehicle speed Vm and the actual vehicle speed Va may be determined in advance (e.g., Vm=1.05×Va). The processor 110 sets the set vehicle speed Vs in accordance with the above Equation (1) in consideration of the relationship between the meter vehicle speed Vm and the actual vehicle speed Va. The set vehicle speed Vs is higher than the first vehicle speed V1. Moreover, the difference between the set vehicle speed Vs and the first vehicle speed V1 is equal to or less than the difference between the meter vehicle speed Vm and the actual vehicle speed Va.

### 3-3. Step S130

In Step S130, the processor 110 executes the vehicle speed control such that the meter vehicle speed Vm does not exceed the set vehicle speed Vs.

### 3-4. Modification Example

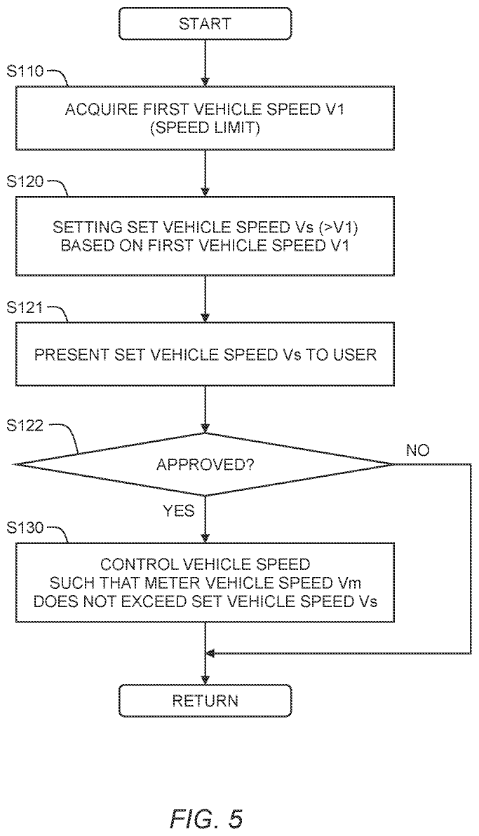

FIG. 5 is a flowchart showing a modification example. In the modification example, the first vehicle speed V1 is the speed limit of the road on which the vehicle 1 travels. Steps S110 and S120 are the same as those in the example shown in FIG. 4.

After Step S120, the processor 110 presents the set vehicle speed Vs (i.e., the speed limit) to the user O and asks the user O for approval (Step S121). For example, the processor 110 displays the set vehicle speed Vs (i.e., the speed limit) on the display device 80 and asks the user O for approval.

The user O uses the input device 70 to approve or reject the set vehicle speed Vs. When the user O approves the set vehicle speed Vs (Step S122; Yes), the processing proceeds to Step S130. On the other hand, when the user O rejects the set vehicle speed Vs (Step S122; No), Step S133 is skipped and the processing returns to Step S110.

### 4. EXAMPLE OF DISPLAYING

The processor 110 displays at least the meter vehicle speed Vm on the speedometer 90. The processor 110 may display the first vehicle speed V1 together with the meter vehicle speed Vm on the speedometer 90.

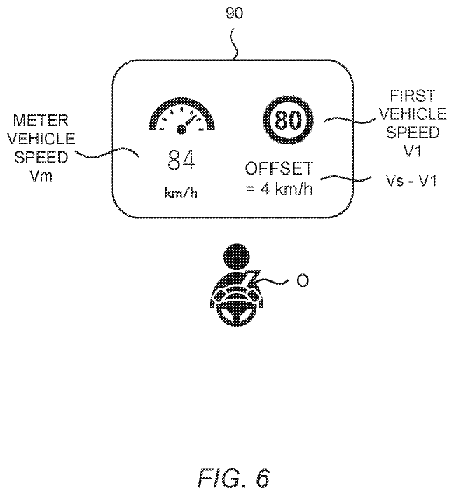

FIG. 6 shows another example of displaying on the speedometer 90. An offset is the difference between the set vehicle speed Vs and the first vehicle speed V1, and corresponds to the correction amount β in the Equation (1). In the example shown in FIG. 6, the processor 110 displays the first vehicle speed V1 and the offset (Vs−V1) on the speedometer 90. In other words, the processor 110 presents the first vehicle speed V1 and the offset (Vs−V1) to the user O. Since the first vehicle speed V1 and the offset are presented to the user O, the user O is able to recognize that the set vehicle speed Vs is intentionally corrected. Accordingly, the user O is able to understand the meaning of the difference between the meter vehicle speed Vm and the first vehicle speed V1. As a result, the user O's sense of strangeness is suppressed.

The processor 110 may further display the set vehicle speed Vs on the speedometer 90.

What is claimed is:

1. A vehicle control method for controlling a vehicle, wherein a meter vehicle speed presented to a user of the vehicle is higher than an actual vehicle speed of the vehicle,
the vehicle control method comprising:
acquiring, as a first vehicle speed, a vehicle speed designated by the user or a speed limit of a road on which the vehicle travels;
setting a set vehicle speed to be higher than the first vehicle speed; and
controlling a speed of the vehicle such that the meter vehicle speed does not exceed the set vehicle speed, wherein
a difference between the set vehicle speed and the first vehicle speed is equal to or less than a difference between the meter vehicle speed and the actual vehicle speed.

2. The vehicle control method according to claim 1, wherein
the difference between the set vehicle speed and the first vehicle speed is equal to the difference between the meter vehicle speed and the actual vehicle speed.

3. The vehicle control method according to claim 1, further comprising:
presenting not only the first vehicle speed but also an offset, which is the difference between the set vehicle speed and the first vehicle speed, to the user.

4. A vehicle control system for controlling a vehicle, wherein a meter vehicle speed presented to a user of the vehicle is higher than an actual vehicle speed of the vehicle,
the vehicle control system comprising one or more processors configured to:
acquire, as a first vehicle speed, a vehicle speed designated by the user or a speed limit of a road on which the vehicle travels;
set a set vehicle speed to be higher than the first vehicle speed; and
control a speed of the vehicle such that the meter vehicle speed does not exceed the set vehicle speed, wherein
a difference between the set vehicle speed and the first vehicle speed is equal to or less than a difference between the meter vehicle speed and the actual vehicle speed.

5. A vehicle speed management method for managing a speed of a vehicle, wherein a meter vehicle speed presented to a user of the vehicle is higher than an actual vehicle speed of the vehicle, and the speed of the vehicle is controlled such that the meter vehicle speed does not exceed a set vehicle speed,
the vehicle speed management method comprising:
acquiring, as a first vehicle speed, a vehicle speed designated by the user or a speed limit of a road on which the vehicle travels; and
setting the set vehicle speed to be higher than the first vehicle speed, wherein
a difference between the set vehicle speed and the first vehicle speed is equal to or less than a difference between the meter vehicle speed and the actual vehicle speed.
